(19) United States
(12) Patent Application Publication
(10) Pub. No.: US 2005/0171774 A1
(43) Pub. Date: Aug. 4, 2005

(54) Features and techniques for speaker authentication

(76) Inventors: Ted H. Applebaum, Santa Barbara, CA (US); Steven Pearson, Santa Barbara, CA (US); Philippe Morin, Santa Barbara, CA (US); Jean-Claude Junqua, Santa Barbara, CA (US)

Correspondence Address: HARNESS, DICKEY & PIERCE, P.L.C., P.O. BOX 828, BLOOMFIELD HILLS, MI, 48303, US

(21) Appl. No.: 10/768,946

(22) Filed: Jan. 30, 2004

(51) Int. Cl. G10L 15/00

(52) U.S. Cl. 704/250

(57) ABSTRACT

A speaker authentication system includes an input receptive of user speech from a user. An extraction module extracts acoustic correlates of aspects of the user's physiology from the user speech, including at least one of glottal source parameters, formant related parameters, timing characteristics, and pitch related qualities. An output communicates the acoustic correlates to an authentication module adapted to authenticate the user by comparing the acoustic correlates to predefined acoustic correlates in a datastore.

### FIELD OF THE INVENTION

The present invention generally relates to speaker authentication systems and methods and particularly relates to speaker authentication using acoustic correlates of aspects of a user's physiology.

### BACKGROUND OF THE INVENTION

Speech representation for speaker verification, identification, and other categories of speaker authentication is generally expressed using the same kinds of acoustic features as are used in speech representation for speech recognition. These tasks, however, have different requirements. For example, speaker verification needs to discriminate between speakers and ignore differences due to speech content. Also, speech recognition needs to discriminate speech content and ignore differences between speakers. As a result, much of the information that may be useful in differentiating speakers is thrown away during the speech parameterization process for speaker recognition. Therefore, it is disadvantageous to express speech for speaker authorization using the same kinds of acoustic features used in speech recognition.

Acoustic correlates of aspects of a speaker's physiology discriminate between different speakers and are difficult for an impostor to fake. Acoustic correlates for vocal tract length are known and may be estimated from the speech signal. Furthermore, it is known that “significant speaker and dialect specific information, such as noise, breathiness or aspiration, and vocalization and stridency, is carried in the glottal signal”, L. R. Yanguas, T. F. Quatieri and F. Goodman, Implications of Glottal Source for Speaker and Dialect Identification, Proc. IEEE ICASSP 1999. Glottal characteristics may be measured by acoustic or non-acoustic means such as laryngograph or ElectroMagnetic (EM) wave sensors. Yet, use of these features has not been made specifically for speaker identification or speaker verification. There remains a need for a speaker authorization system and method that effectively employs these features that are typically overlooked or even discarded. The present invention fulfills this need.

### SUMMARY OF THE INVENTION

In accordance with the present invention, a speaker authentication system includes an input receptive of user speech from a user. An extraction module extracts acoustic correlates of aspects of the user's physiology from the user speech, including at least one of glottal source parameters, formant related parameters, timing characteristics, and pitch related qualities. An output communicates the acoustic correlates to an authentication module adapted to authenticate the user by comparing the acoustic correlates to predefined acoustic correlates in a datastore

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram illustrating a networked embodiment of the speaker authentication system according to the present invention;

FIG. 2 is a flow diagram illustrating a networked embodiment of the speaker authentication method according to the present invention;

FIG. 3 is a graph illustrating glottal source parameters extracted in accordance with the present invention; and

FIG. 4 is a graph illustrating speech pitch, waveform and formant trajectories extracted in accordance with the present invention.

### DETAILED DESCRIPTION OF THE PREFERRED EMBODIMENTS

The following description of the preferred embodiments is merely exemplary in nature and is in no way intended to limit the invention, its application, or uses.

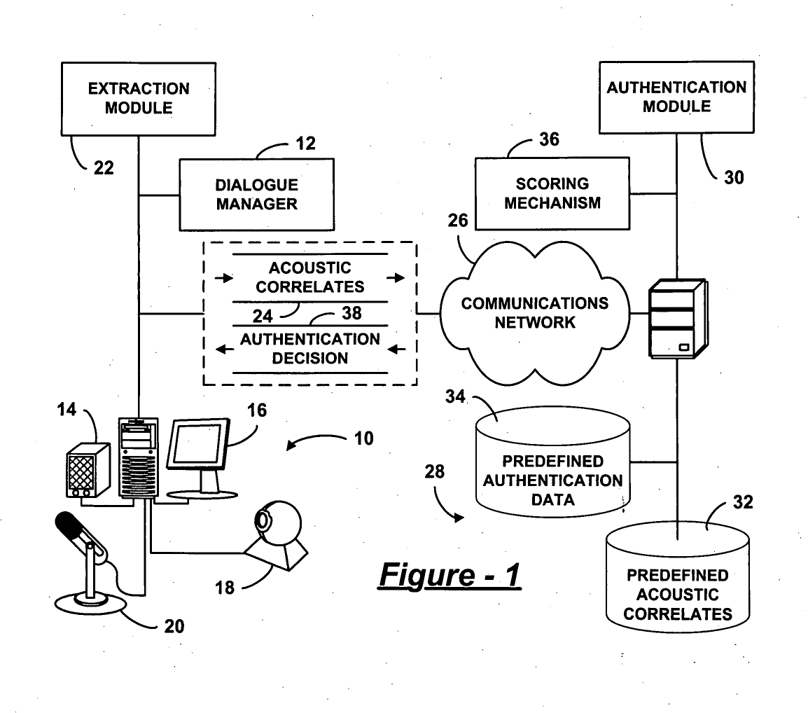

Starting with FIG. 1, a networked embodiment of the system according to the present invention provides an overview. In particular, a remote location 10 provides a dialogue manager 12 employing an audio output 14 to prompt a user to copy a speech output. In particular, the dialogue manager 12 prompts the user to copy the speech output while simultaneously performing a distracting task. According to various embodiments, the user may be prompted to copy speech corresponding to the user's presumed name while simultaneously signing the user's name via an input mechanism such as touchscreen 16. Alternative or additional distracting tasks include providing a biometric such as a fingerprint, retina or iris scan, facial image, or other, additional authentication data. An image capture mechanism 18 may therefore be provided at the remote location.

Audio input 20 receives the user speech resulting from the user copying the speech prompt, and extraction module 22 extracts acoustic correlates 24 of aspects of the user's physiology from the user speech. These acoustic correlates include glottal source parameters, formant related parameters, timing characteristics, and/or pitch related qualities. These extracted correlates 24 are transmitted across communications network 26 to central location 28, where authentication module 30 compares the correlates to predefined acoustic correlates in datastore 32. Additional authentication characteristics, such as the user's signature, may also be transmitted to the central location and compared to predefined authentication data of datastore 34. Scoring mechanism 36 is adapted to rescore and combine comparison results for feature sets of differing modalities by using combining weights that are sensitive to changes in context and environment. Accordingly, authentication module 30 is adapted to generate an authentication decision 28 and transmit it over network 38 to the remote location 10.

It is envisioned that the speaker authentication system of the present invention may be configured differently according to varying embodiments. For example, an alternative networked embodiment may have a scoring mechanism at the remote location that is adapted to receive and combine multiple authentication decisions. Also, a stationary, non-networked embodiment may have a single location with the extraction and authentication modules co-located with or without a scoring mechanism. Further, a mobile, non-networked embodiment may have a scoring mechanism that is adapted to dynamically adjust to changes in context and environment according to changes in location.

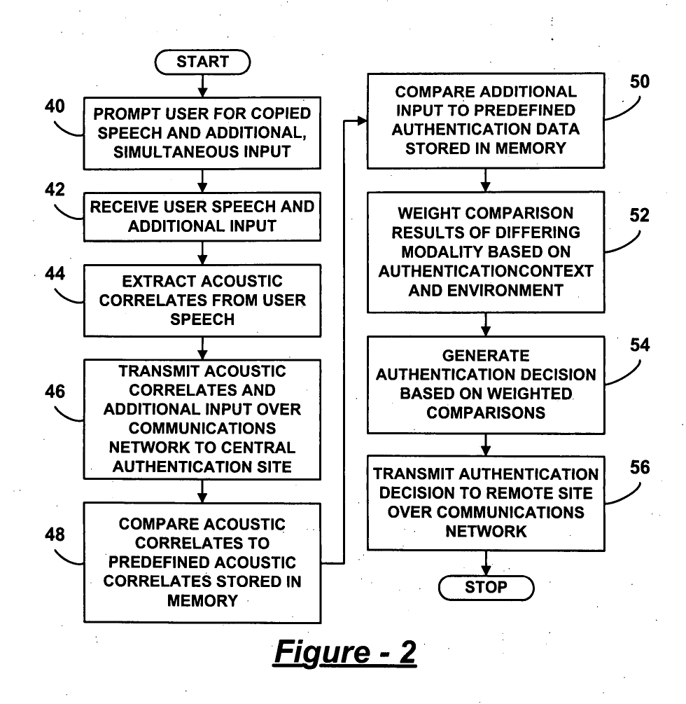

In operation, the networked system according to the present invention performs the steps illustrated in FIG. 2. It is envisioned that a non-networked system may have less steps, and that various embodiments may have differently ordered steps and/or additional steps. Thus, the speaker authentication method described in detail below may have varying implementations that will become readily apparent to those skilled in the art based on the following description.

Starting at step 40, the user at a remote location is initially prompted via speech synthesis to copy a speech output while simultaneously performing a distracting task, such as providing an additional input. The copy speech technique helps to isolate certain features and improve discrimination. In particular, several of the glottal source parameters co-vary with pitch, while at the same time pitch can be quite variable within the same speaker. Thus, it is better to control the pitch of the trial speech. This control can be accomplished by asking the speaker to copy a prompt both during enrollment and at the time of verification. Copy speech can also provide more stability with other kinds of features, and integrates well with the challenge/response approach.

Additional distracting tasks are required of the user during speech verification to degrade an imposter's performance by increasing the cognitive load. If, for example, one is asked to copy a speech prompt and at the same time sign one's own name, an imposter will have a difficult time executing both tasks simultaneously because he or she is trying to forge a signature. The true applicant, however, will have little difficulty due to great familiarity with the task. This distracting task technique differentially degrades the performance of the imposter and improves the ability of the system to discriminate imposters from true users.

At step 42, the user speech and additional input are received simultaneously. Acoustic correlates of the user's physiology are then extracted from the user speech at step 44. The extracted acoustic correlates can include glottal source parameters, formant related parameters, timing characteristics, and pitch related qualities. Types of extracted glottal source parameters can include spectral qualities, breathiness and noise content, jitter and shimmer related to fluctuations in pitch period and amplitude, and glottal source waveform shape, which is equivalent to phase information. Types of extracted formant related parameters can include the pattern of high formants related to shapes and cavities in the head, an estimate of vocal tract length, low formant patterns indicating accent or dialect, nasality related to velum opening, and formant bandwidth. Extracted timing characteristics may include phoneme level timing, which is in part dependent on physiology. Pitch related qualities may include characteristic pitch gestures derived from clustered training data.

In accordance with the present invention, spectral qualities are extracted based on a spectral parameterization of the glottal source. Typically, the glottal source is approximated as a residual waveform, derived from target speech by inverse filtering, and in such a way as to remove the resonant effects of the vocal tract. In this “time-domain” form, a number of parameters can be computed. For example, peak amplitude, RMS amplitude, zero-crossing rate, autocorrelation function, arc-length of waveform, etc. Alternatively, the glottal wave can be observed in the frequency-domain by applying the Fourier transform. In this case, some alternate parameters (“qualities”) can be computed from the data. For example, the Fourier coefficients themselves (but this has high dimensionality), the energy fall-off rate per frequency, characteristic shapes of the magnitude or phase as a function of frequency, relations of the phase and magnitude of first few harmonics, the arc-length of the Fourier coefficients as plotted in the Z-plane as a function of frequency, etc.

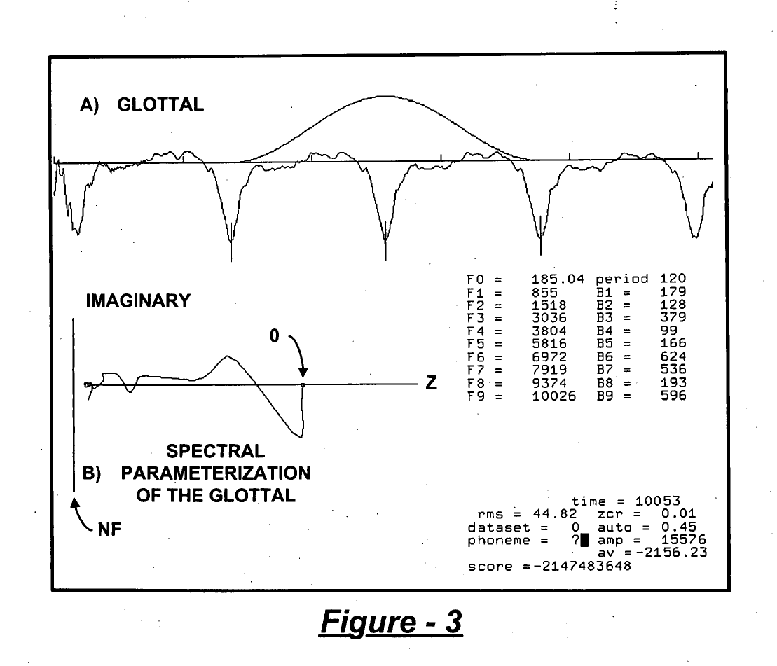

FIG. 3 illustrates an example of glottal source parameters. The top of the figure at A illustrates a portion of the glottal waveforms, and the bottom at B shows spectral parameterization of the glottal, including the corresponding trajectory in the Z plane of the complex value of the DFT at each frequency from zero at the right end to the Nyquist frequency at the left.

Another glottal source parameter that may be extracted in accordance with the present invention, breathiness, is a subjective quality that most people can identify, but quantitative measurement is not so simple. Yet some researchers have identified measurable parameters that correlate with breathiness. These are: (a) aspiration noise, (b) larger open quotient (duty cycle) of glottal airflow, (c) faster energy falloff with frequency (spectral tilt).

An additional glottal source parameter that may be extracted in accordance with the present invention, noise content, is produced by turbulence in the vocal tract. This turbulence occurs at a point of constriction, such as at the glottis, or where the tongue approaches the top of the mouth or teeth, or where the lips come together. Different people have varying skills at making these sounds, or may have an inherent noise in the glottal source. Extraction of noise parameters is similar to other qualities, in that the data can be examined in either the time-domain or frequency-domain. Serra Xavier, Smith Julius, “Spectral Modeling Synthesis: A Sound Analysis/Synthesis System Based on a Deterministic plus Stochastic Decomposition”, Computer Music Journal, Vol 14, No 4, 1990, describes a way to separate the noise waveform from the periodic waveform. Given the isolated noise waveform, one can compute zero crossing rate, energy, etc., which characterize different kinds of noise. Also, Fourier analysis can be applied to give the energy content as a function of frequency. Alternatively, an indicator of noise is the “normalized arc length” of the inverse filtered residual waveform.

Yet another set of glottal source parameters that may be extracted in accordance with the present invention, jitter and shimmer, is characteristic of the glottal folds of an individual. The vibration of the glottis is fairly consistent and periodic, however there is a chaotic element as the glottal folds come into physical contact. This causes slight perturbations in the pitch period and the pressure wave amplitude on a period to period basis. These are called, respectively, jitter and shimmer. Given a single extracted glottal pulse waveform, one can measure the period and amplitude. Then for a sequence of pulses, one can compute a variance about a moving average. Alternatively, another measure of jitter and shimmer can be computed as a ratio of autocorrelation coefficients A[n]/A[0], where n corresponds to the fundamental period.

Still another glottal source parameter that may be extracted in accordance with the present invention, is glottal source waveform shape related to phase information. Some researchers claim that the ear only hears spectral magnitude information. But two glottal waveforms can have the same spectral magnitude, yet have different phase information, and hence a different actual waveform shape. Using inverse filtering of speech one obtains an actual waveform shape, and further, it has been observed that different people have different shaped glottal waveforms. Yet one has to be careful using this information for discriminating speaker identity, since the shape also changes considerably with varying phoneme, pitch, sentence position, and semantic intent. However, forcing a speaker to utter a particular phrase, at a particular pitch and speed, and then extracting data from a particular phoneme and averaging glottal pulses, allows one to obtain a waveform representative of the speaker. This can be measured against other glottal pulses using typical means, such as normalizing and computing RMS difference.

Formant related parameters, such as a pattern of high formants, may further be extracted in accordance with the present invention. Formants are the resonances of the vocal tract. A resonance occurs approximately every thousand Hertz, starting around five hundred Hertz. During speech, the frequency and bandwidth of the lowest three formants move around considerably. It is well known that these parameters carry the content of the speech, the identity of the phoneme sequence. The higher formants (4, 5, 6, . . . ) move around much less, but somewhat sympathetically with the lower formants. But between speakers the spacing between the higher formants is characteristically different. For example, formants four and five might stay close together, and formants six and seven stay close together, while these two pairs stay noticeably apart. The “pattern” can be measured as ratios or differences amongst the formant frequencies and bandwidths, and used for discriminating speaker identity.

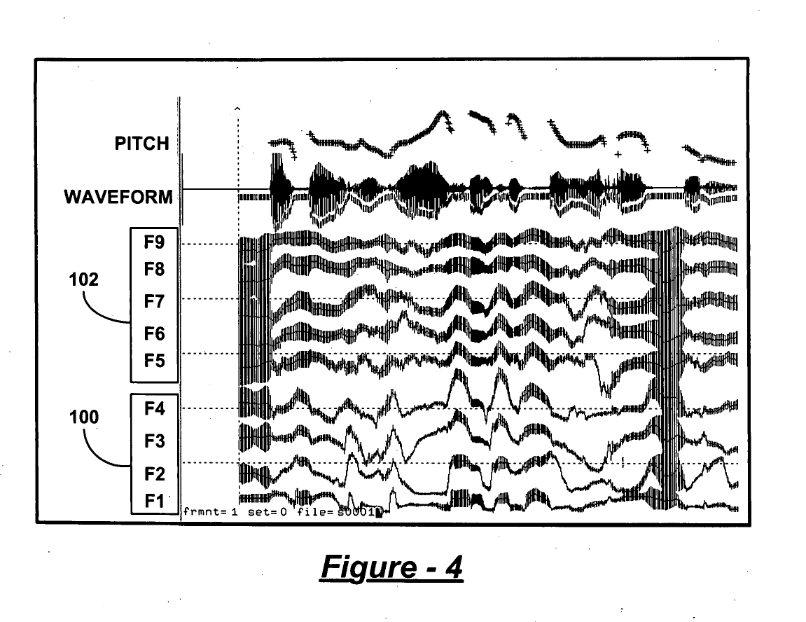

FIG. 4 illustrates the first nine formants for an utterance. In this case, the lower formants 100, F1 through F4, vary strongly with the phonetic content of the utterance. The higher formants 102, F5 through F9, stay closer to constant values that are characteristic of the speaker's vocal tract size and shape. Each formant exhibits its own characteristic formant bandwidth.

Another formant related parameter, lower formant patterns, may also be extracted in accordance with the present invention. Dialectal variations are often correlated with differences in the trajectory shapes of the low three formants. Even average formant values can be indicative for some phonemes and dialects. These variations can be measured by formant estimation followed by averaging or spline fitting.

Yet another formant related parameter, vocal tract length, may be extracted in accordance with the present invention. Hisashi Wakita, “Direct Estimation of the Vocal-Tract Shape by Inverse Filtering of Acoustic Speech Waveforms”, IEEE Transactions on Audio and Electroacoustics, October, 1973, has described how to estimate vocal tract shape from the formant frequencies and bandwidths. Inverse filtering methods, described by Steven Pearson, “A Novel Method of Formant Analysis and Glottal Inverse Filtering”, Proc. ICSLP 98, Sydney Australia, 1998, can give superior formant frequency and bandwidth estimation, even up to ten formants. Thus a method for extracting vocal tract length is made possible, and vocal tract length is a characteristic of speaker identity.

Still another formant related parameter, nasality, may be extracted in accordance with the present invention. Nasality is a subjective quality that most people can identify, but quantitative measurement is not so simple. The quality is related to an amount of opening of the velum, and obstructions in the nasal and oral passages. In turn this amount of opening and obstruction affects the balance of energy coming from the nose as opposed to coming from the mouth. Such noticeable changes in nasality occur around nasal phonemes N, M, NG, where the velum is purposefully controlled. Experimental inquiry has determined that several measurable parameters correlate with these cases: for example, formant bandwidths, glottal waveform arc-length, and presence of spectral zeros.

Another type of parameter, characteristics at a phoneme level, may be extracted in accordance with the present invention. Some phenomena occur at a level higher than phoneme (super-segmental), such as a pitch gesture covering several words, or a change in voice source quality that covers several voiced phonemes. However some measurable phenomena relate to the particular articulations for a certain phoneme. For example, the formant targets of a particular vowel, or the voice onset time (time between plosive burst and beginning of voicing) for a particular voiceless plosive—vowel combination, or the micro-prosodic pitch perturbation corresponding to a certain phoneme.

A further type of parameter, pitch related qualities, may be extracted in accordance with the present invention. Parameters thus extracted may include quantities that correlate with pitch (this happens since the glottis moves up or down with pitch, and the glottal wave shape and spectral shape change with pitch). Examples are: spectral tilt, amplitude, some formant frequencies or bandwidth. Alternatively or additionally, one can derive certain measures from the pitch function over an utterance. Examples are: maximum, minimum, average pitch, and pitch slopes. An extreme example is as follows: collect a code-book of normalized (and clustered) pitch gestures from a speaker, then at authentication time, compare a new gesture to the codebook.

At step 46, the extracted acoustic correlates and additional input are then transmitted over a communications network, such as the Internet, to a central authentication site. Many commercially interesting applications require authentication over a network. Thus, the enhanced feature set (conventional acoustic features plus new ones), are preferably transmitted. Combining weights indicative of context and environment at the remote location may be simultaneously transmitted to the central location. The precise set of features to be transmitted may be included in a standard yet to be determined.

The received acoustic correlates are then compared to predefined acoustic correlates stored in processor memory at step 48. The additional input, such as a user signature or other biometric, is also compared to predefined authentication data stored in processor memory. It is envisioned that a passcode may alternatively or additionally be required. Results of comparison respective of feature sets of varying modalities are then weighted and combined according to context and environment by a scoring mechanism at step 52. In particular, the present invention combines multiple sets of features using combining weights that are sensitive to changes in the context and environment. For example, one may combine recognition based Cepstral features, synthesis based glottal source features, formant based features, and non-auditory features, such as image and/or handwriting. Unexpected variations which arise, such as background noises, differing light sources, or a sore throat would normally degrade the accuracy of speaker verification. The scoring algorithm according to the present invention dynamically adjusts the emphasis or de-emphasis of each modality, or feature set, according to control parameters derived from the unpredictable context or environment. Examples include auditory signal to noise ratio or luminance level, or changes to nasality and breathiness.

An authentication decision is then generated based on the weighted comparisons at step 54. Finally, the decision is transmitted back to the remote location over the communications network at step 56. The decision may accordingly be employed at the remote location to govern granting access to remote resources.

In order to confirm the efficacy of performing speaker recognition according to the features and techniques of the present invention, various experimental trials were conducted. One such set of experimental trials explored use of spectral qualities of glottal source. The authentication system according to the present invention uses a variety of parameters, which are combined using statistical methods. The goal of the particular experimental trials described below was to see if parameters alone, which can be called spectral qualities of glottal source, were in themselves useful for speaker verification. For this purpose, a new test program was used.

Multiple speakers were recorded saying the same five phrases at least fifteen times. An analysis was applied to all recordings, which computed formant frequencies and bandwidths, and which also inverse filtered the waveform to yield a glottal waveform that was devoid of formant resonances. Several other parameters were derived during the same analysis. These additional derived parameters included short-term autocorrelation, short-term RMS amplitude, short-term normalized arc-length of waveform before and after inverse filtering, and voiced versus non-voiced decision.

In particular, a non-standard spectral analysis was pitch-synchronously computed on the glottal waveform. First, a Hamming window was applied to capture exactly two adjacent glottal pulses, with a pitch epoch point exactly in the middle. Then, a discrete Fourier transform (DFT) was computed for this windowed waveform. The programmed method calls the resulting complex function F (ω), where ω is the radian frequency and the function is defined from ω=0 up to ω=2*π (or equivalently, the sample rate). Next, the program computes (dF(ω)/dω)/F(ω), that is, the derivative of F with respect to ω, divided by F. This function is also a complex function, but the real part is anti-symmetric and the imaginary part is symmetric. Thus, applying an inverse DFT to this function yields a real part, which is zero, and an imaginary part, which is “cepstrum like”, carrying information in the low coefficients.

From glottal pulse to pulse, these coefficients are “noisy”, carrying information that represents rapidly moving spectral zeros and magnitude fluctuations. However, if the results from many pulses are averaged, certain stationary properties of the speaker become apparent. Using an RMS distance between these “cepstrum like” coefficients revealed short distances between phrases spoken by the same speaker, and significantly further distances between phrases by different speakers.

An additional experimental trial was conducted with respect to vocal tract length. It has been shown by Hisashi Wakita, “Normalization of Vowels by Vocal-Tract Length and Its Application to Vowel Identification”, IEEE Transactions on Acoustics, Speech, and Signal Processing, VOL. ASSP-25, No 2, April 1977, and others that the vocal tract length can be estimated from the formant frequencies and bandwidths. Since the analysis technique according to the present invention yields reliable formant values, even at high sampling rates such as 16 KHz, it is possible to compute this parameter on a frame-by-frame basis. When averaged over entire phrases, this parameter was fairly consistent for a single speaker, and thus was able to distinguish between speakers with different size vocal tracts.

A further method was developed and tested for location of transient noise with the glottal pulse. The points in time, within the glottal pulse, of transient noise, which together make up the noise of aspiration, can be indicative of a particular speaker. Since techniques of the present invention provide a method of formant tracking and inverse filtering to remove resonances from the residual glottal waveform, it is possible to measure these characteristic time-points.

A glottal pulse will be most similar to the one preceding it in time; hence it is possible to take the arithmetic difference to get a waveform representing the random changes. If, for each glottal pulse, this difference waveform is normalized in time and made positive by squaring or by taking the absolute value, patterns can be detected by averaging these waveforms over many glottal pulses.

These experimental trials and others further revealed the efficacy of employing frame classes and averaging methods in accordance with the present invention. Many of the methods described above use averaging, and details about this technique are therefore provided below.

Generally, it is useful to average across speech sounds of the same type. For example, there are open vowels, constricted sonorants such as W, R, Y, L, voiced nasal sounds like N, M, NG, soft voiced fricatives TH, V, loud voiced fricative like Z, ZH, unvoiced fricatives S, F, etc., and transient noise like P, T, K, and silence. It is not generally advisable to average frames across these “classes”, so we use heuristics to identify the class of each frame (or glottal pulse, when voiced), and do averaging over frames of like class.

The heuristics can involve parameters mentioned before, such as RMS energy, pitch, voicing, and normalized arc-length. In particular, the difference between the normalized arc length of waveform, before and after inverse filtering, can be used to distinguish between strong open vowels, versus nasal sounds, versus other sonorant sounds. Also, a relatively large normalized arc-length indicates a strong fricative such as S, Z, F, and ZH.

The description of the invention is merely exemplary in nature and, thus, variations that do not depart from the gist of the invention are intended to be within the scope of the invention. Such variations are not to be regarded as a departure from the spirit and scope of the invention.

1. A speaker authentication system, comprising:
an input receptive of user speech from a user;
an extraction module adapted to extract acoustic correlates of aspects of the user's physiology from the user speech, including at least one of glottal source parameters, formant related parameters, timing characteristics, and pitch related qualities; and
an output communicating the acoustic correlates to an authentication module adapted to authenticate the user by comparing the acoustic correlates to predefined acoustic correlates in a datastore.

2. The system of claim 1, wherein said extraction module is adapted to extract glottal source parameters that include spectral qualities.

3. The system of claim 1, wherein said extraction module is adapted to extract glottal source parameters that include breathiness.

4. The system of claim 1, wherein said extraction module is adapted to extract glottal source parameters that include noise content.

5. The system of claim 1, wherein said extraction module is adapted to extract glottal source parameters that include at least one of jitter and shimmer related to fluctuations in pitch period and amplitude.

6. The system of claim 1, wherein said extraction module is adapted to extract glottal source parameters that include glottal source waveform shape related to phase information.

7. The system of claim 1, wherein said extraction module is adapted to extract formant related parameters that include a pattern of high formants related to head shapes and cavities.

8. The system of claim 1, wherein said extraction module is adapted to extract formant related parameters that include an estimate of vocal tract length.

9. The system of claim 1, wherein said extraction module is adapted to extract formant related parameters that include low formant patterns related to at least one of accent and dialect.

10. The system of claim 1, wherein said extraction module is adapted to extract formant related parameters that include an estimate of nasality related to velum opening.

11. The system of claim 1, wherein said extraction module is adapted to extract formant related parameters that include formant bandwidth.

12. The system of claim 1, wherein said extraction module is adapted to extract timing characteristics at a phoneme level.

13. The system of claim 1, wherein said extraction module is adapted to extract pitch related qualities that include characteristics derived from clustered training data.

14. The system of claim 1, further comprising a dialogue manager adapted to require the user to copy speech of a prompt when providing the user speech.

15. The system of claim 1, further comprising a dialogue manager adapted to require the user to perform a distracting task while providing the user speech input.

16. The system of claim 1, further comprising a scoring mechanism adapted to combine multiple feature sets differentiated according to modality using combining weights that are sensitive to changes in context and environment.

17. The system of claim 1, further comprising a communications network conveying the acoustic correlates to the authentication module, wherein the authentication module is adapted to generate an authentication decision and transmit the decision across the network to an input of the speaker authentication system.

18. A speaker authentication method, comprising:
receiving user speech from a user;
extracting acoustic correlates of aspects of the user's physiology from the user speech, including at least one of glottal source parameters, formant related parameters, timing characteristics, and pitch related qualities; and
communicating the acoustic correlates to an authentication module adapted to authenticate the user by comparing the acoustic correlates to predefined acoustic correlates in a datastore.

19. The method of claim 18, further comprising extracting glottal source parameters that include spectral qualities.

20. The method of claim 18, further comprising extracting glottal source parameters that include breathiness.

21. The method of claim 18, further comprising extracting glottal source parameters that include noise content.

22. The method of claim 18, further comprising extracting glottal source parameters that include at least one of jitter and shimmer related to fluctuations in pitch period and amplitude.

23. The method of claim 18, further comprising extracting glottal source parameters that include glottal source waveform shape related to phase information.

24. The method of claim 18, further comprising extracting formant related parameters that include a pattern of high formants related to head shapes and cavities.

25. The method of claim 18, further comprising extracting formant related parameters that include an estimate of vocal tract length.

26. The method of claim 18, further comprising extracting formant related parameters that include low formant patterns related to at least one of accent and dialect.

27. The method of claim 18, further comprising extracting formant related parameters that include an estimate of nasality related to velum opening.

28. The method of claim 18, further comprising extracting formant related parameters that include formant bandwidth.

29. The method of claim 18, further comprising extracting timing characteristics at a phoneme level.

30. The method of claim 18, further comprising extracting pitch related qualities that include characteristics derived from clustered training data.

31. The method of claim 18, further comprising requiring the user to copy speech of a prompt when providing the user speech.

32. The method of claim 18, further comprising requiring the user to perform a distracting task while providing the user speech input.

33. The method of claim 18, further comprising combining multiple feature sets differentiated according to modality by using combining weights that are sensitive to changes in context and environment.

34. The method of claim 18, further comprising:
conveying the acoustic correlates to the authentication module via a communications network; and
receiving an authentication decision generated by the authentication system via the communications network.
